(19) United States
(12) Patent Application Publication
(10) Pub. No.: US 2016/0350508 A1
(43) Pub. Date: Dec. 1, 2016

(54) RECOMMENDING AVAILABLE MEDICATION BASED ON SYMPTOMS

(71) Applicant: International Business Machines Corporation, Armonk, NY (US)

(72) Inventor: Derek L. Howard, Rochester, MN (US)

(21) Appl. No.: 14/726,671

(22) Filed: Jun. 1, 2015

(51) Int. Cl. G06F 19/00

(52) U.S. Cl. CPC G06F 19/3456; G06F 19/326; G06F 19/321

(57) ABSTRACT

Medication can be recommended by a computer system that receives symptoms and can access available medications. A profile for the symptoms is used to determine medications that can be used to treat the symptoms. The medications can then be compared to a list of medications available for use. Based on the comparison, one or more medications that are both available for use and appropriate for treatment of the symptoms are recommended to a user.

### BACKGROUND

The present disclosure relates to recommendation of medication, and more specifically, to recommending home medical treatment.

Computer processing circuits carry out a variety of instructions of a computer program by performing basic functions contained within the stored instructions of the program. These instructions can be modified to carry out a number of different functions and processes. These functions and processes can be carried out over a network, which allows for greater connectivity between personal computers, smart phones, laptops, and other devices.

Various web pages may recommend medicine for injuries or other medical issues. When using these web pages, a user may look up a particular disease or ailment based on identified symptoms. The safety of the information on the web pages may be unreliable when consulted for medical treatment recommendation.

### SUMMARY

Embodiments of the present disclosure may be directed toward a computer implemented method for recommending medication to a user, the recommendation based on symptom data input by the user and medication available to the user. A computer system can receive a set of symptom data from a device and via a user interface. From a database, the system can access a profile associated with the symptom data. The profile can have medication data associated with the symptom data. The system can identify medications associated with the symptom data and retrieve medication data associated with the user from a server. The system can compare the identified medications associated with the symptom data with the set of medication data associated with the user, and identify based on the comparison, medications associated with the user and associated with the set of symptoms. The system can then transmit to the device the identified medications associated with the user and associated with the set of symptoms.

Embodiments of the present disclosure may be directed toward a computer system for recommending medication to a user, where the recommendation is based on symptom data input into a device and medication available to the user. The system may comprise at least one processor circuit comprising a symptom entry monitoring module configured to receive a set of symptom data from the device. The circuit may also have a profile access control module that can access a profile associated with the symptom data. The profile may have medication data associated with the symptoms. The module can also identify medications associated with the set of symptom data. The circuit may also comprise a comparing module configured to retrieve medication data associated with the user and compare the medication data associated with the user with the identified medications associated with the symptom data. The module can then identify medications associated with the user and with the symptoms, based on the comparing. The circuit can also have a recommending module configured to transmit the identified medications to the device.

Embodiments of the present disclosure may be directed toward a computer program product for recommending medication to a user, where the medication may be recommended based on symptom data input by the user into a device and medication available to the user. The computer program product may comprise a computer readable storage medium with program instructions, where the computer readable storage medium is not a transitory signal per se. The program instructions may cause the circuit to perform the method that includes receiving a set of symptom data from the device and accessing a profile associated with the symptom data from a database. The profile may have medication data associated with symptom data. Medications associated with the symptom data may be identified and medication data associated with the user may be retrieved from the server. The medication data associated with the user can be compared with the identified medication associated with the user. Based on the comparing, medication associated with the user and associated with the set of symptoms can be identified. The identified medication associated with the user and the set of symptoms can then be transmitted to the device.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of a system for recommending medication to a user, consistent with embodiments.

FIG. 2 depicts a flow diagram of a method for recommending medication to a user, based on symptoms provided by the user, consistent with embodiments.

FIG. 3 depicts a flow diagram of a method for recommending medication to a user based on available medications and symptoms provided by the user, consistent with embodiments.

FIG. 4A depicts example devices on which a user interface (UI) may be used to receive symptoms and recommend medications, consistent with embodiments.

FIG. 4B depicts a UI of a device in 4A, used for recommending medications, consistent with embodiments.

FIG. 5 depicts a cloud computing node according to an embodiment of the present invention;

FIG. 6 depicts a cloud computing environment according to an embodiment of the present invention; and

FIG. 7 depicts abstraction model layers according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to recommendation of medication, more particular aspects relate to recommending home medical treatment. While the present disclosure is not necessarily limited to such applications, various aspects of the disclosure may be appreciated through a discussion of various examples using this context.

Various embodiments are directed toward a computer system that can actively maintain databases of symptoms and medications to provide dynamic medication treatment recommendations to users based on a user's symptoms and medication available to the user. According to embodiments, the computer system can be configured to identify and recommend a medication based on a user's particular symptom and current contents of the user's medicine cabinet. The system can be configured to receive, from a device (e.g., a smart phone or tablet computer), a set of symptom data. This symptom data could be entered through a user interface (UI) on the device. This symptom data could reflect the current user's symptoms. The symptom data could also reflect the symptoms being experienced by another. For example, if the user was a family care giver, the symptoms could be that of the ailing family member.

Prior to the input of the symptoms, the user could have entered into the device medication he or she currently has available. For example, the user may take inventory of the medications in his or her medicine cabinet and elsewhere throughout his or her home. Whenever new medicine is purchase or filled (over-the-counter or prescription, respectively), it can be added to a database by the application, so that at all times, the database on the application accurately reflects the medication available to the user.

Upon receiving the symptom data from the user, the computer system can access a profile associated with the symptom data. The profile can be included in a symptom database. This symptom database can include a number of profiles, with each profile associating a particular set of symptoms with a group of one or more medications. These medications can be ones that are known to be effective in treating the particular set of symptoms with which they are associated in the profile. The profiles can be created through, for example, data mining and through the system using natural language processing technologies to “ingest” medical textbooks, FDA safety information, prescription and over-the-counter drug labels, or other information.

From the profile, the system can identify one or more medications that are associated with the symptoms entered by the user. The device could also prompt the user for more information or with clarifying questions, if the set of symptoms provided does not provide a broad enough picture for the system to access, with a necessary level of confidence, a particular profile and the associated medications.

The system can also, at the same time as it is accessing the profile, or before, or after, retrieve the set of medication data associated with the user. For example, once the user enters the medications he or she has on hand, this data can be stored in a local database. In response to receiving a data set of symptoms from the user, the system can access a set of medication data associated with the particular user. For example, a user profile, a user account, or specific log in credentials for a specific user could be used to associate a user with the set of medication available to him. In this way, multiple users could store and access personalized medication data on a single device.

The system may then compare the retrieved set of medication data associated with the user (i.e., the medications the user currently has on-hand) with the one or more medications identified based on the profile (i.e., the medications associated with the symptom data set). Based on the comparison, the system identifies one or medications appearing in both groups. This medication, the identified medicine for treating the symptoms, is then transmitted to the user via the UI on the device. If there is no overlap, the system can still recommend a medication, which the user would then need to purchase prior to treatment.

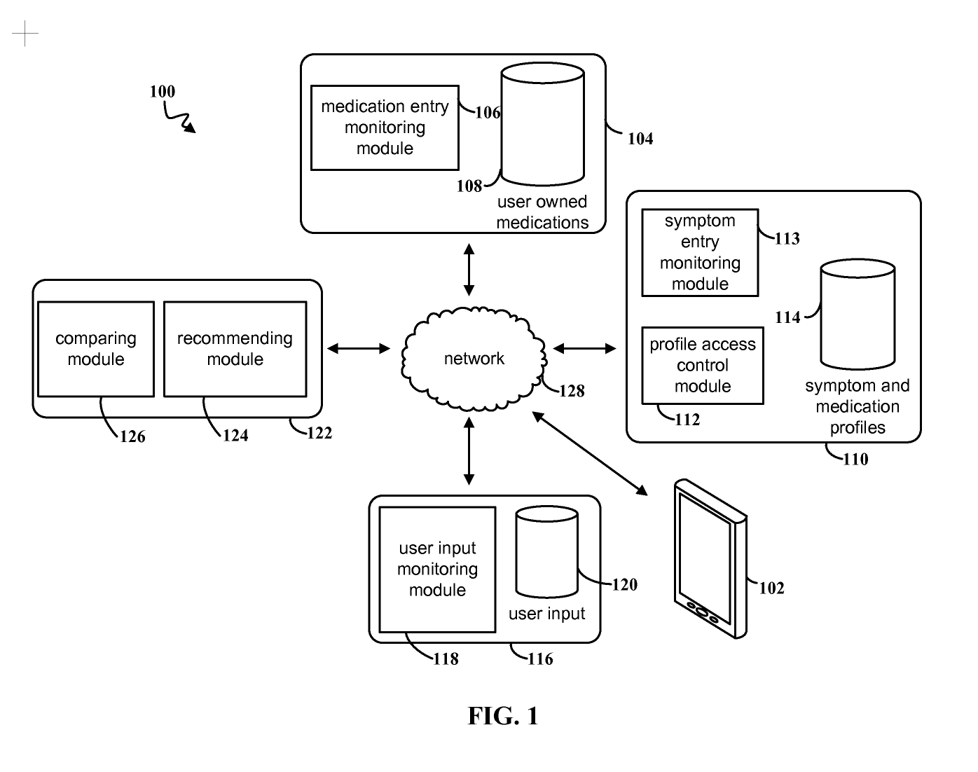

FIG. 1 depicts a block diagram of a system for recommending medication to a user, consistent with embodiments. The system 100 can be configured to receive input from a user device 102. This device can have a UI and touch screen capabilities. The user device can include, but is not limited to, a tablet device, a smart phone, a personal music device, and a personal computer. The user device 102 can obtain a visual display for the UI over a network 128 and display the visual display. The network 128 can include one or more networks that can include, but are not limited to, local area networks, point-to-point communications, wide area networks, the global Internet, and combinations thereof.

In embodiments, a local module can be initiated on the user device 102 in order to monitor and record input into the user interface (e.g., through touch screen events or entered text). For example, the UI could include one or more images including photographs of a medication, graphics, selectable buttons, boxes to input text, or other features. The device may have a designated function or setting which monitors input (by for example scanning, photographing, or typing) that is identified as a medication. This input can be handled by the system 100 differently than other input.

According to embodiments, the local module can be configured to transmit the input identified as medication to a medication entry monitoring module 106 over the network 128. The monitoring module and other modules and engines discussed herein, can be stored on a computer readable medium as instructions that are configured to run on one or more processor circuits corresponding to one or more monitoring server devices 104. The medication can be stored in a database 108, which can aggregate medication information for a particular user over time. The database can also store other data relevant to the medication, including for example, an expiration date, date of purchase, location of purchase, or other data relevant to the medication. For a prescription medication, the database 108 could also include the prescribing doctor, name and location of fulfilling pharmacy, number of refills left, or other data.

In embodiments, a user may enter one or more symptoms into device 102. This data may be stored in a local module configured to transmit the symptom data over the network 128 to a symptom entry monitoring module 113. This module 113 can communicate with a profile access control module 112, in order to access a database 114. The modules 113 and 112 and the database 114 can be stored and run on a server device 110. The database 114 can store profiles wherein sets of symptoms are grouped with medications that are known to be effective in treating the particular set of symptoms. In this way, the symptom entry monitoring module 113 can communicate with the profile access control module 112 to deliver the particular set of symptoms input by the user into the device 102. The profile access control module 112 can use the particular set of symptoms to access the appropriate profile in the database 114.

If an appropriate profile cannot be accessed from the database 114 by the profile access control module 112, due to, for example, an incomplete or general symptom set, the system could prompt the user device 102 for more information (e.g., additional symptoms) or pose additional queries to the user via a UI on the user device 102. In response to the prompting, the user could enter one or more responses or symptoms into the device 102. This input could be transmitted over a network by a local module configured to transmit the input, to a user input monitoring module 118. The input could be compiled in a user input database 120. The data in the database could be associated with a particular user or particular device. The data could include any additional input (other than medication) provided to the device 102. The module 118 and the database 120 could be reside on one or more server devices 116. These one or more server devices 116 could be separate from, connected to, or the same as the server devices 104, 110, and 122.

The symptom and medication profiles database 114 can be compiled and updated based on current medical standards. The database could be updated periodically. The database 114 could also be associated with a natural language processing engine, which could update the database upon receipt of new studies, medication, or published notices.

A comparing module 126 and a recommending module 124 could be stored on a server 122. The comparing module can be configured to receive, from the profile access control module 112, a profile associated with the symptoms entered by the user into the user device 102. The comparing module can also access a set of user owned medications from the database 108. As described herein, the medications can be grouped according to a particular user, a particular device, or in some other fashion. The comparing module 126 can then compare the medications from the appropriate profile obtained from database 114 with the appropriate list of medications (e.g., for the particular user, device, location, etc.). From the comparing, the comparing module 126 can identify a set of one or more medications that the user has on hand (as evidenced by presence in the user owned medication database 108) that is appropriate for treating the indicated set of symptoms.

The comparing module 126 can then be configured to transmit the set of one or more medications to the recommending module 124, which can be configured to transmit, to the user device 102, over the network 128, the set of one or more medications identified by the comparing module 126. As discussed herein, if the comparing module 126 determines there is a null set of medications that are both owned by the user and appropriate to treat the symptoms, the recommending module 124 may identify one or more medications that are appropriate to treat the relevant symptoms and which the user may then need to procure.

In another example, a user may be at a drug store, in an effort to procure medications (either his usual prescriptions or medication specific to a particular ailment). The user may touch a selectable portion of the screen on the touchscreen portion of the user device 102, in order to see which medications he currently has at home and which medications he needs to pick up for himself and other members of his household. In response to the user's selection on the UI of the device 102, a local module on the device may transmit, over the network 128, the user's selection to the user input monitoring module 118. This data may be stored in the user input database 120. The module 118 may access, over the network 128, the medication entry monitoring module 106. This module 106 could then pass the appropriate set or sets of user owned medications 108 to the recommending module 124. The recommending module 124 could then transmit the set of medications to the user device 102, to be displayed. Thus, the user could access a current list of medications he or other family members own (along with relevant data associated with the medications). An emergency medical professional could also access the medication list owned by a particular user. For example, if an EMT is responding to a call, and the user is unable to respond to questions, the EMT could, from the user's device, access a list of the current medications the user has been prescribed.

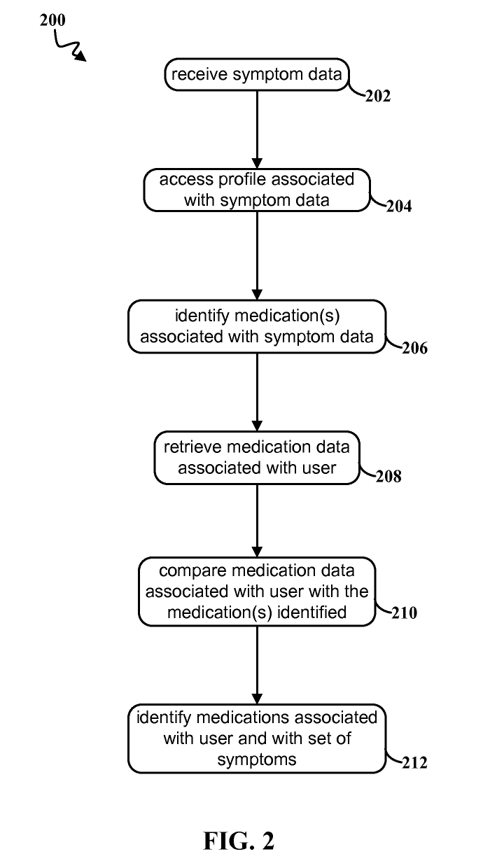

FIG. 2 depicts a flow diagram of a method for recommending medication to a user, based on symptoms provided by the user, consistent with embodiments. The method 200 can begin when the system receives symptom data from a user device, per 202. The symptom data may be a set of one or more symptoms that the user is experiencing and for which the user is seeking a treatment. In another example, the user could be a family or friend caretaker, entering symptoms of the ailing person.

The system can then access a profile associated with the symptom data received, per 204. As described herein, the profile may contain both a symptom or set of symptoms and the associated medication or set of medications used to treat the symptoms. The profiles can be actively updated using a cognitive computing system that can learn as the medical field expands its knowledge, or by using a data mining algorithm, or in another way. For example, a profile can be created by mining, relative to the symptoms, a database for medications, and determining a set of medications used for treatment of the set of symptoms. This set of medications associated with the symptoms can then be stored in a profile for the particular set of symptoms. In this way, the symptom and medication association can be accurate and up-to-date based on current (e.g., at the particular moment the symptoms are being entered) data available for safe and effective treatment of the symptom set. Based on the profile, the system can then identify medication or a set of medications associated with the symptom data, per 206. The system can then retrieve medication data associated with the user, per 208. This can be data entered previously by a user to reflect the current medications owned by the user. In some embodiments, the medications entered into the device can then be identified by the system and associated with the data available about the medication on various websites or journals, via the Internet, or from another source. The medication can be entered manually. The medication could also be input by photographing the medication if the device has photo recognition capabilities. The medication could also be input by scanning a label or code on the medication.

By comparing the medication data associated with the user (e.g., the medication the user owns), with the medication or set of medications identified by the system based on the profile, per 210, the system can identify one or more medications owned by the user that may be helpful in treating the relevant symptoms, per 212.

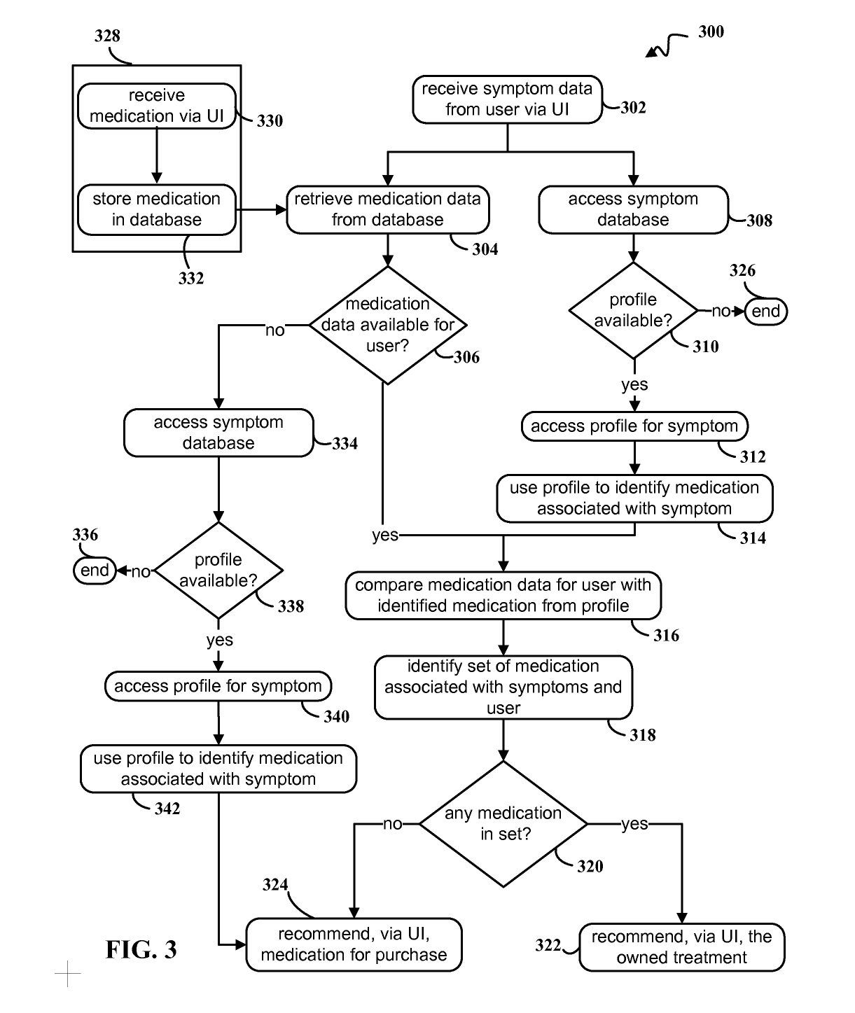

FIG. 3 depicts a flow diagram of a method for recommending medication to a user based on available medications and symptoms provided by the user, consistent with embodiments. The method 300 can comprise a flow of data which recommends medication to a user based on input symptoms. The method 300 can also comprise another flow of data, demarcated by the steps in 328. This portion of the method 300 can occur before, after, or during the rest of the flow, and these steps are purposed to provide an accurate representation of a set of medications currently owned by or available to the user. In this process, the system can receive, via a UI on a user device, identifying information about a specified medication, per 330. The identifying information could be the name of the medication, a photograph of the medication label, or a scan of a barcode on the medication, or another piece of identifying information. The system can store the information about the medication in a database, associating each piece of information with the particular user or account that was active during the entry of the data, per 332.

The method 300 can begin when the system receives symptom data from a user via a UI on a user device, per 302. This symptom data could be a set of one or more symptoms the user is experiencing. The system could then access the symptom database, per 308 and determine the availability of a profile associated with the symptom set, per 310. The profile can associate the set of symptoms with one or more medications that are used to treat the symptoms. In some embodiments, if no profile is available for the particular set of symptoms, the flow will end and no medication will be recommended to the user, per 326.

If a profile associated with the set of symptoms is available at 310, the system can access the profile associated with the symptom(s), per 312. The system can then identify a medication or medications associated with the symptom based on the profile, per 314.

Also in response to receiving symptom data from a user via a UI, per 302, the system can retrieve medication data from a database, per 304. The database can be on one or more servers, and can be the database in which the medication input by the user, reflective of the medication currently owned by the user, is stored. For example, this could be database 108 from FIG. 1. The system can then determine, per 306, if medication data is available for the particular user. For example, if the user has only recently created an account with the system, or if the user has neglected to enter any medication information into the device, the system may determine at 306 that there is an absence of medication data for the particular user. If this determination is made, the system may access the symptom database, per 334. This can be the same database accessed at 308, which contains profiles that associate each particular set of symptoms with one or more medications used to treat the symptoms. The system can then determine if a profile associated with the particular set of symptoms is available, per 338. If the system determines that no profile is available for the set of symptoms, then the method can end, per 336, and the system may not provide a recommendation to the user. If, at 338, the system determines that a profile for the symptoms is available, the system can access the profile for the symptoms, per 340, and use the profile to identify a medication associated with the symptom, per 342. The system can then recommend, via a UI on the user device, a medication or medications for purchase. Each of the one or more recommended medications can be one used to treat the particular set of symptoms input to the system by the user.

In embodiments, if at 306, medication data is available for the user, the system can compare that medication data associated with the user with the set of medication data identified at 314, per 316. Based on this comparison, a set of medications can be identified that is both associated with (e.g., owned by) the user and used to treat the particular set of symptoms, per 318. If one or more medications are identified in the set, at 320, the system can recommend those medications to the user, via the UI on the user device, for treatment of the input symptoms, per 322. If the set is a null or empty set, that can indicate that there are no medications recommended to treat the particular set of symptoms that are currently associated with the user (e.g., the user owns). If this is the case at 320, the system can recommend, via a UI, one or more medications for purchase, to treat the relevant symptoms, per 324.

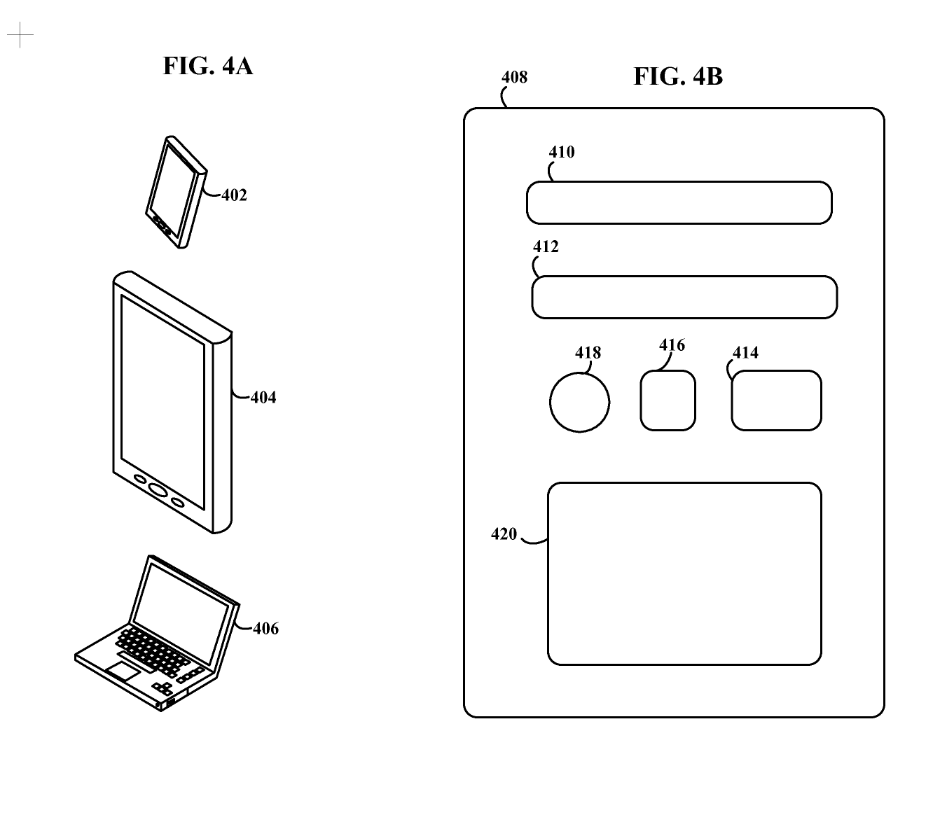

FIG. 4A depicts example devices on which a user interface (UI) may be used to receive symptoms and recommend medications, consistent with embodiments. Devices include a smart phone 402, a tablet device 404, and a laptop computer 406. Devices for entry of the symptom data are in no way limited to those depicted, and may include a digital camera, a scanning-equipped device, a pharmacy or drugstore owned computer system, or another device.

FIG. 4B depicts a UI of a device in 4A, used for recommending medications, consistent with embodiments. The UI 408 depicted here can include various fields for text entry or display including fields 410, 412, and 420. The UI can also include any number of selectable options 414, 416, and 418. The selectable options can include text entry or display fields, but can also include navigational buttons. For example, field 410 could be a selectable option, and could also serve as a location for entry of symptom data. Symptom data entered manually into this field could be submitted to the system, as described for example in FIG. 1, or could prompt a number of selectable options based on a predictive display. Field 412 could serve as a selectable option to lead to a list of various other inputs, or it could be a location for a user to manually input medication, in one mode (e.g., medication entry mode). In another mode (e.g., symptom entry mode) field 412 could also be a place for a user to manually enter responses or additional information to the system based on a prompt or additional query from the system (in order to allow the system to, e.g., accurately select a profile based on symptoms). Field 420 could be the location on the UI at which the system provides medication recommendations or requests additional data via prompts, queries, or in another way. Field 420 could also be a location on which a current list of medication could be displayed, for example if the user wishes to identify a current list of medications and quantity of those medications he has on hand (i.e., without entering any symptoms).

Selectable option 414 could be a navigational button which a user may select in order to access a current listing of medication associated with the user or the particular account. In this way, the user could access an up-to-date list of medication and associated relevant data (as described in, e.g., FIG. 1). Selectable option 418 could be a button which a user could select to notify the system that a photo (i.e., photographic data) is being taken or accessed, in order to add a particular medication to the database. It could also serve to notify the system that a photograph is being taken or accessed, to serve as a symptom identifier (e.g., a photograph of a particular type of edema), in another mode. A third selectable option 416 could serve as an “enter” or “send” button, in order to indicate to the device and system that the user has completed the particular task. For example, selectable option 416 could be selected once a user has completed his or her entry of symptoms.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

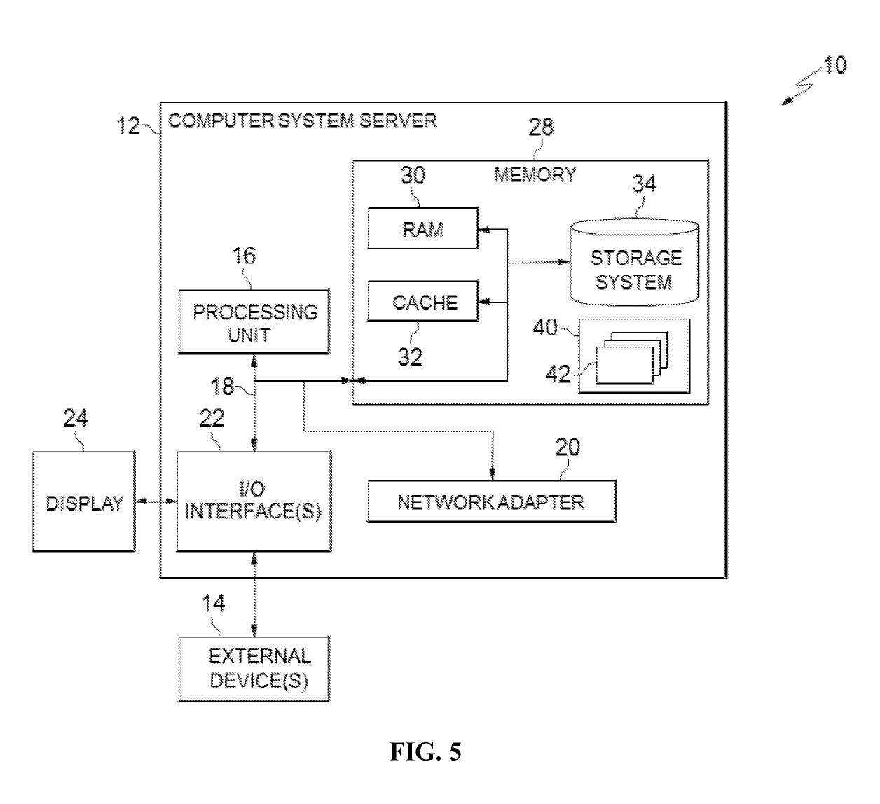

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types.

Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

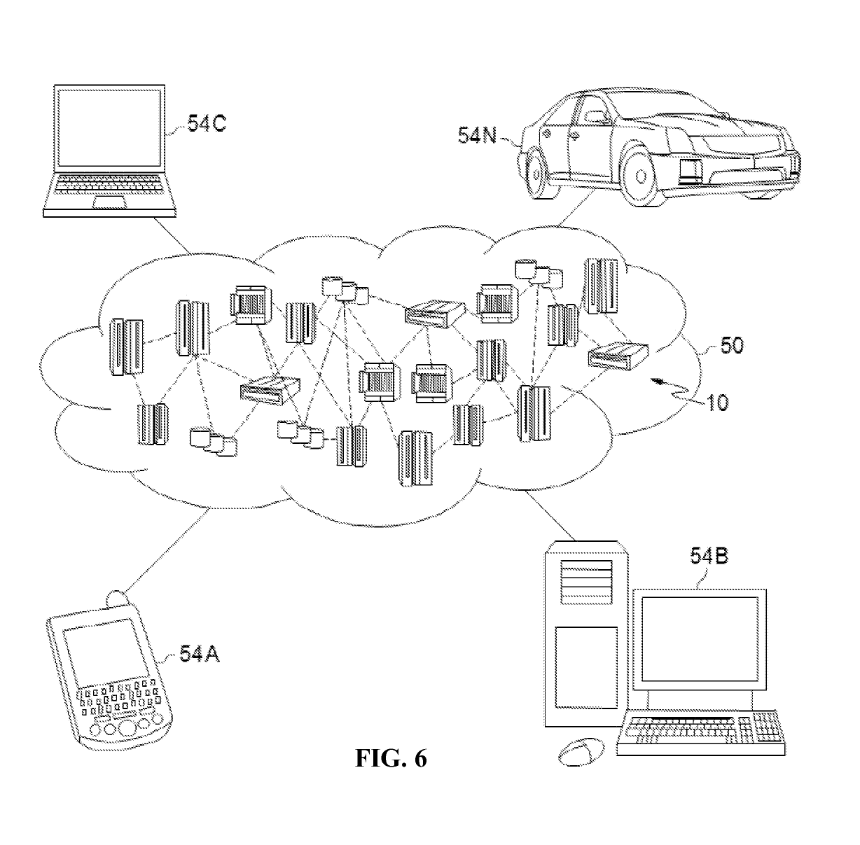

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

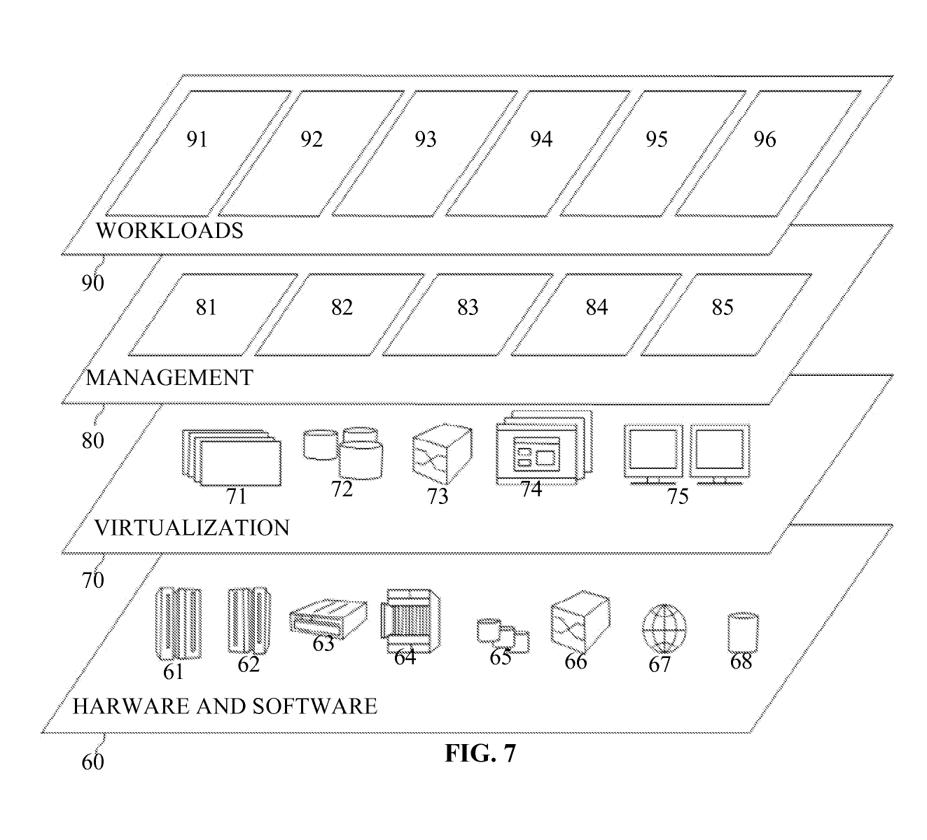

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and recommending available medications based on symptoms 96.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for recommending medications to users, the method comprising:
receiving, from the device and via a user interface (UI), a set of symptom data for a user;
accessing, from a database, a profile associated with the set of symptom data, the profile comprising medication data associated with sets of symptom data;
identifying, from the profile, one or more medications associated with the set of symptom data;
retrieving, from a server, a set of medication data associated with the user;
comparing, with the set of medication data associated with the user, the one or more identified medications associated with the set of symptom data;
identifying, based on the comparing, one or more medications associated with the user and associated with the set of symptoms; and
transmitting, to the device, the one or more identified medications associated with the user and associated with the set of symptoms.

2. The method of claim 1, further comprising:
receiving, from the device and via the UI, a second set of symptom data for a second user;
accessing, from the database, a second profile associated with the second set of symptom data, the second profile comprising medication data associated with sets of symptom data;
identifying, from the second profile, one or more medications associated with the second set of symptom data;
determining, an absence of medication data associated with the second user;
identifying, by the server and based on the one or more medications associated with the second set of symptom data, one or more medications appropriate for treatment of the second set of symptoms; and
transmitting, to the device, the one or more medications appropriate for treatment of the second set of symptoms.

3. The method of claim 1, wherein the set of symptom data comprises text and photographic data.

4. The method of claim 1, further comprising:
mining, relative to the set of symptoms, a database for medications;
determining a particular set of medications used for treatment of the set of symptoms; and
storing, in a profile for the set of symptoms, the particular set of medications.

5. The method of claim 1, wherein the set of medication data associated with the user comprises prescription medication and over-the-counter medication.

6. The method of claim 1, further comprising:
receiving, from the user, medication data input, the medication data input comprising medications prescribed the user and medications owned by the user; and
creating, based on the medication data input, the set of medication data associated with the user.

7. A computer system for recommending medications to users, the system comprising:
at least one processor circuit comprising:
a symptom entry monitoring module configured to:
receive, from the device and via a user interface (UI), a set of symptom data for the user;
a profile access control module configured to:
access, from a database, a profile associated with the set of symptom data, the profile comprising medication data associated with sets of symptom data;
identify, from the profile, one or more medications associated with the set of symptom data;
a comparing module configured to:
retrieve, from a server, a set of medication data associated with the user;
compare, with the set of medication data associated with the user, the one or more identified medications associated with the set of symptom data; and
identify, based on the comparing, one or more medications associated with the user and associated with the set of symptoms; and
a recommending module configured to:
transmit, to the device, the one or more identified medications associated with the user and associated with the set of symptoms.

8. The computer system of claim 7, wherein the modules of the at least one processor circuit are configured to:
receive, from the device and via the UI, a second set of symptom data for a second user;
access, from the database, a second profile associated with the second set of symptom data, the second profile comprising medication data associated with sets of symptom data;
identify, from the second profile, one or more medications associated with the second set of symptom data;
determine, an absence of medication data associated with the second user;
identify, based on the one or more medications associated with the second set of symptom data, one or more medications appropriate for treatment of the second set of symptoms; and
transmit, to the device, the one or more medications appropriate for treatment of the second set of symptoms.

9. The computer system of claim 7, wherein the set of symptom data comprises text and photographic data.

10. The computer system of claim 7, wherein the modules of the at least one processor circuit are further configured to:
mine, relative to the set of symptoms, a database for medications;
determine a particular set of medications used for treatment of the set of symptoms; and
store, in a profile for the particular set of symptoms, the particular set of medications.

11. The computer system of claim 7, wherein the set of medication data associated with the user comprises prescription medication and over-the-counter medication.

12. The computer system of claim 7, wherein the at least one processor circuit further comprises a medication entry monitoring module configured to:
receive, from the user, medication data input, the medication data input comprising medications prescribed the user and medications owned by the user; and
create, based on the medication data input, the set of medication data associated with the user.

13. A computer program product for recommending medications to users, the computer program product comprising a computer readable storage medium having program instructions embodied therewith, wherein the computer readable storage medium is not a transitory signal per se, the program instructions executable by a computer processing circuit to cause the circuit to perform the method comprising:
receiving, from the device and via a user interface (UI), a set of symptom data;
accessing, from a database, a profile associated with the set of symptom data, the profile comprising medication data associated with sets of symptom data;
identifying, from the profile, one or more medications associated with the set of symptom data;
retrieving, from a server, a set of medication data associated with the user;
comparing, with the set of medication data associated with the user, the one or more identified medications associated with the set of symptom data;
identifying, based on the comparing, one or more medications associated with the user and associated with the set of symptoms; and
transmitting, to the device, the one or more identified medications associated with the user and associated with the set of symptoms.

14. The computer program product of claim 13, further comprising:
receiving, from the device and via the UI, a second set of symptom data for a second user;
accessing, from the database, a second profile associated with the second set of symptom data, the second profile comprising medication data associated with sets of symptom data;
identifying, from the second profile, one or more medications associated with the second set of symptom data;
determining, an absence of medication data associated with the second user;
identifying, by the server and based on the one or more medications associated with the second set of symptom data, one or more medications appropriate for treatment of the second set of symptoms; and
transmitting, to the device, the one or more medications appropriate for treatment of the second set of symptoms.

15. The computer program product of claim 13, wherein the set of symptom data comprises text and photographic data.

16. The computer program product of claim 13, further comprising:
mining, relative to the set of symptoms, a database for medications;
determining a particular set of medications used for treatment of the set of symptoms; and
storing, in a profile for the particular set of symptoms, the particular set of medications.

17. The computer program product of claim 13, wherein the set of medication data associated with the user comprises prescription medication and over-the-counter medication.

18. The computer program product of claim 13, further comprising:
receiving, from the user, medication data input, the medication data input comprising medications prescribed the user and medications owned by the user; and
creating, based on the medication data input, the set of medication data associated with the user.
